(19) United States
(12) Patent Application Publication
(10) Pub. No.: US 2025/0014099 A1
(43) Pub. Date: Jan. 9, 2025

(54) MULTI-CHAIN TRADING APPLICATION

(71) Applicant: Chainbloq Labs, Inc., St. Petersburg, FL (US)

(72) Inventors: Cengiz Dincoglu, St. Petersburg, FL (US); Orkun Mahir Kilic, Istanbul (TR); Sait Berk Ozdogan, West New York, NJ (US); Mustafa Ilker Ulutas, Istanbul (TR)

(21) Appl. No.: 18/766,121

(22) Filed: Jul. 8, 2024

Related U.S. Application Data
(60) Provisional application No. 63/525,486, filed on Jul. 7, 2023.

(51) Int. Cl. G06Q 40/04; G06Q 30/06

(52) U.S. Cl. CPC G06Q 40/04; G06Q 30/06; G06Q 2220/00

(57) ABSTRACT

Various aspects of the subject technology relate to systems, methods, and machine-readable media for interconnecting multiple blockchains for trading purposes is provided. Various aspects may include initiating a transaction for a user in a host blockchain implementing first smart contracts. Aspects may also include generating, at the host blockchain, a message including details of the transaction. Aspects may also include transmitting, via a bridge, the message including the details of the transaction to a target blockchain implementing second smart contracts. Aspects may also include user's balance in the first and second smart contracts based on the message/transaction.

### CROSS-REFERENCE TO RELATED APPLICATIONS

The present disclosure is related and claims priority under 35 U.S.C. § 119 (e), to U.S. Provisional Patent Application No. 63/525,486, entitled MULTI-CHAIN TRADING APPLICATION BASED ON GENERIC MESSAGING, to Cengiz Dincoglu et al., filed on Jul. 7, 2023, the contents of which are hereby incorporated by reference in their entirety, for all purposes.

### TECHNICAL FIELD

The present disclosure is related to a multi-blockchain trading application in which a target blockchain is coupled with host-blockchains using messaging protocols. The target blockchain may be used as an extension of the host-chain. More specifically, the present disclosure is directed to token deposit, withdrawal, transfer and swapping (trading) of blockchain assets in a multi-chain platform using smart contracts and one or more third-party bridge applications.

### BACKGROUND

Cryptocurrency wallets (or ‘crypto wallets’) are software or hardware tools that enable users to store, use, and manage digital assets on blockchain networks. Cryptocurrencies exist solely as digital records on distributed ledgers and do not rely on physical currency and centralized institutions. However, there is a need for individuals and organizations to understand ownership of digital assets and to be able to know how much is held, much like a bank account provides a bank balance.

Users can use crypto wallets to validate account balances, providing visibility into how much digital assets the user owns, receive digital assets, and interact with Web3 decentralized applications (dApps) and decentralized finance (DeFi) services. DeFi users may use smart contract platforms to trade native or fungible tokens in blockchains. Typically, blockchains provide a native coin by default that is used for transactions. A crypto wallet has to have native tokens of the blockchain it operates to be able to execute any of the transactions and pay transaction fees (or ‘gas’). Users must acquire the native token before they can execute any operations on the network, creating a barrier to entry and limiting interoperability between different blockchain ecosystems. Other methods such as bridge applications or wrapping tokens are needed to transfer assets from an original blockchain to another blockchain. As the number of blockchain networks increase, users encounter growing challenges in effectively managing their assets across multiple platforms. This can also lead to confusion and potential errors as the number of assets and blockchains involved increases.

### BRIEF SUMMARY

The subject disclosure provides for systems and methods for multi-blockchain trading, interconnecting multiple blockchains to a subnet blockchain. A default gas abstraction is also provided in the multi-blockchain trading. According to embodiments, a computer-implemented method for the multi-blockchain trading is provided. The method includes initiating a transaction for a user in a host blockchain implementing first smart contracts. The method also includes generating, at the host blockchain, a message including details of the transaction. The method also includes transmitting, via a bridge, the message including the details of the transaction to a target blockchain implementing second smart contracts. The method also includes updating a first balance in the first smart contract of the host blockchain based on the message. The method also includes updating a second balance in the second smart contracts of the target blockchain by an amount based on the transaction.

According to embodiments, a system is provided including a processor and a memory comprising instructions stored thereon, which when executed by the processor, cause the processor to perform operations for multi-blockchain trading. The operations may include initiating a transaction for a user in a host blockchain in a network, the host blockchain implementing first smart contracts. The operations may further include generating, at the host blockchain, a message including at least a host symbol and host chain identification (ID). The operations may further include transmitting, via a bridge, the message to a target blockchain implementing second smart contracts. The operations may further include mapping the host symbol to a symbol that is shared across host blockchains in the network. The operations may further include updating a first balance in the first smart contract of the host blockchain based on the message. The operations may further include updating a second balance in the second smart contracts of the target blockchain by an amount based on the transaction.

According to embodiments, a non-transitory computer-readable storage medium is provided including instructions (e.g., stored sequences of instructions) that, when executed by a processor, cause the processor to perform a method for multi-blockchain trading. The method includes initiating a transaction for a user in a host blockchain in a network, the host blockchain implementing first smart contracts. The method also includes generating, at the host blockchain, a message including at least a host symbol and host chain identification (ID). The method also includes transmitting, via a bridge, the message to a target blockchain implementing second smart contracts. The method also includes mapping the host symbol to a symbol that is shared across host blockchains in the network. The method also includes updating a first balance in the first smart contract of the host blockchain based on the message. The method also includes updating a second balance in the second smart contracts of the target blockchain by an amount based on the transaction.

These and other embodiments will become clear to one of ordinary skill in the art, in view of the following.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram of a device operating environment with which aspects of the present disclosure can be implemented.

FIG. 2 is a block diagram illustrating a trading workflow of a multi-chain application, according to certain aspects of the present disclosure.

FIG. 3 is an example block diagram illustrating components in a blockchain network, according to certain aspects of the present disclosure.

FIG. 4 is a block diagram illustrating a blockchain asset management system, according to certain aspects of the present disclosure.

FIG. 5 is an example flow diagram for token transactions between host blockchains and target blockchains, according to certain aspects of the present disclosure.

FIG. 6 illustrates a sample token list, according to certain aspects of the present disclosure.

FIG. 7 illustrates an exemplary list of tokens (shared symbols) in a subnet, according to certain aspects of the present disclosure.

FIG. 8 is an example flow of a method for withdrawing an asset, according to certain aspects of the present disclosure.

FIG. 9 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

### General Overview

Cryptocurrency wallets (or ‘crypto wallets’) are software or hardware tools that enable users to store, use, and manage digital assets on blockchain networks. Cryptocurrencies exist solely as digital records on distributed ledgers and do not rely on physical currency and centralized institutions. However, there is a need for individuals and organizations to understand ownership of digital assets and to be able to know how much is held, much like a bank account provides a bank balance. Users can use crypto wallets to validate account balances, providing visibility into how much digital assets the user owns. Crypto wallets enable users to send and receive digital assets and serves as a primary mechanism for managing cryptocurrency balances. Crypto wallets are also required to interact with Web3 decentralized applications (dApps) and may be used in decentralized finance (DeFi) services.

Typically, blockchains and smart contracts typically require gas fees in a native token of the blockchain for executing transactions. A crypto wallet has to have gas tokens of the blockchain it operates to be able to execute any of the transactions and pay transaction fees (or ‘gas’). When users sign up with a crypto wallet provider, they are automatically assigned one or more blockchain addresses (similar to bank account numbers). In some implementations, these blockchain addresses have zero (0) digital assets balances including the gas token of the blockchain. However, these addresses need to be funded with a small amount of gas tokens from other addresses to be able to start executing transactions. This creates a friction point for a user whenever they wish to operate in a new blockchain, forcing the user to find ways to procure gas tokens along with their initial transaction.

DeFi users may use smart contracts (e.g., Automated Market Makers (AMMs)) to trade native or fungible tokens in blockchains by connecting their crypto wallet to a dApp. To move a token from a source blockchain to a target blockchain for a given transaction (e.g., trading, staking, etc.), a bridge application is required. A bridge is a paid service/application that facilitates the transfer of tokens from one chain to another. In some embodiments, bridge applications are created and operated by third parties. In a conventional bridge used to send a token from the source blockchain to the target blockchain, the token is “wrapped” by the bridge (e.g., converted to a target token based on the target blockchain). In this case, the user's crypto wallet at the target blockchain receives a bridge version of the source blockchain token that has been converted to a fungible token in Virtual Machine (VM) compatible blockchains. Blockchain networks may include application-level logic defined by multiple VMs which enable more decentralized networks.

Wrapping consists of locking or burning a token on the source blockchain and then releasing or minting on the target blockchain. These actions can be reversed to move a token back to the source blockchain. Once a user receives a token in the target blockchain, they are free to use them as they please because the asset is in the crypto wallet in the target blockchain, giving the user full control. Typically, the source blockchain address and the target blockchain addresses are the same. Users may then interact with one or more dApps through the user's crypto wallet. However, as the number of assets and blockchains increases, the slight variations in asset names across different blockchains can lead to increased confusion and a higher risk of errors. Conventionally, blockchain transactions require the person sending the transaction to pay for gas. The gas is used to pay validators for the computing power on the network and transaction fees.

Blockchains are assigned a native coin (gas token) at their creation, which cannot be changed once they are assigned. The exact price of the gas is determined by supply, demand, and network capacity at the time of the transaction. In a proof of stake blockchain, gas fees are the reward for staking the native coin and participating in validation—the more a user has staked, the more they can earn. A gas limit is the maximum amount of work that a validator is expected to perform on a particular transaction. A higher gas limit may indicate that the user believes the transaction will require more work. The gas price is the price per unit of work done (i.e., a transaction cost is the gas limit multiplied by the gas price). Transactions may also include tips, which are added to the gas price. In some implementations, the more you pay (e.g., higher tip), the faster a transaction is completed. The lower a user estimates their gas limit, the transaction will have a lower priority in a queue for processing transactions in the network.

Gas abstraction refers to a mechanism that enables users to pay gas fees using multiple currencies or tokens. Users can pay transaction fees using any token supported by the relaying entity rather than being limited to the network's gas token. In some instances, a relaying entity is not used and the users' crypto wallet gas balances in the subnet are constantly monitored and automatically replenished for a seamless experience by the smart contracts. However, if this automatic process is not in place, users must maintain their gas balance another way. For example, users may request for gas tokens from friends/administrators to be manually airdropped to their crypto wallet at the time of the very first deposit as they start with a balance of zero gas tokens. As another example, when the user consumes all the initial gas deposited in their crypto wallet, they can deposit additional gas tokens acquired from trading into their crypto wallet. As another example, if they run out of gas tokens in the subnet contracts, users can manually swap their own tokens for gas tokens. If none of the above options work, users must again ask friends/administrators for a gas token airdrop. These additional steps create unnecessary friction and additional steps for the user.

Embodiments as disclosed herein provide a solution to the above-mentioned problems rooted in computer technology, namely, a multi-blockchain trading system. The disclosed subject technology improves the functioning of the computer itself by enabling multi-blockchain trading in a blockchain network by tightly coupling a target blockchain with one or more host-blockchains using messaging techniques. The target blockchain may be used as an extension of the host-chains rather than as a completely independent blockchain. Aspects of embodiments are not limited to implementations in specifically blockchains and may be implemented in or between, for example, any two blockchains, subnets, or VMs.

According to embodiments, the multi-blockchain trading system enables token deposits, withdrawals, transfers and swapping (trading) of blockchain assets in the multi-chain platform by using smart contracts and one or more third-party bridge applications. Some embodiments include a blockchain (subnet) where token balance management for a given crypto wallet is offloaded to the same smart contracts. In some embodiments, gas token balance management in the crypto wallets is automatically handled in the background by the smart contracts on behalf of the user.

The disclosed subject technology further provides improvements to the technological field by facilitating an autofill for gas abstraction. Whenever a user interacts with the subnet smart contracts using their crypto wallet (e.g., deposit, send tokens to an address, add an order, cancel an order, etc.), the autofill automatically replenishes the user's gas balances, if necessary, in the background without any user involvement.

The multi-chain (or dual-chain) architecture of the multi-blockchain trading system does not require wrapping/unwrapping of tokens from/to an originating chain. According to embodiments, users may deposit their token or blockchain asset into a smart contract in their originating/host chain from their crypto wallet. When the asset is deposited, the actual assets are locked in a smart contract in the host chain. A generic message is automatically sent to the smart contract counterpart in the target blockchain/subnet via a third-party bridge. Once the message is received by its counterpart, the user's address is credited for the asset.

In some embodiments, due to an absence of digital asset contracts in the subnet, the digital assets cannot be released to the user's crypto wallet. In embodiments, users can exchange their assets with any other asset that is deemed tradable by administrators in the subnet (i.e., subnet admins). Therefore, after thousands of trades, users can decide to withdraw their most recent holdings which are tracked by the subnet contract back to any supported host chain. As the entry and exit points for the multi-blockchain trading system are gated by the smart contracts, the sum of the tokens in the host blockchains will be equal to the sum of the tokens in the target blockchain throughout.

According to some embodiments, a withdraw request is initiated by the user, and the subnet sends a generic message back to the host blockchain. Subsequently, the amount of the withdrawal is unlocked from the host blockchain's smart contracts and released back to the user's crypto wallet in the host blockchain, thus lowering the locked balances of the token in the host blockchain's smart contract.

Accordingly, a subnet as disclosed herein provides asset users a true decentralized fully on-chain, central limit order book (CLOB) exchange that has low cost and increased speed. The subnet contracts may include a liquidity aggregation feature that combines multiple assets into a single order book. By allowing multiple blockchains to deposit assets with the subnet using generic messaging, native coins, tokens, and other assets from one host blockchain can be traded as one with their wrapped equivalents from another host blockchain. This commingling of assets as well as bridge-agnostic features are handled transparently by the smart contracts. As such, according to some embodiments, the subnet architecture is bridge agnostic and includes multiple bridges and allows a user to interact with any desired blockchain. This approach further reduces the risk of single point failure at the bridge and opens access to the subnet for trading assets from other host blockchains in the network.

Some embodiments include strategies for optimizing withdrawals in a multi-chain network by incentivizing host blockchains with holders of large asset inventories and de-incentivizing host blockchains with lower asset inventories. This enables self-managed inventory at the host blockchains.

According to some embodiments, subnet contracts are the primary mechanism for managing users' digital assets balances instead of their crypto wallets. They enable users to send and receive digital assets to/from any address within the subnet smart contracts in addition to managing balances resulting from users' trading activity. No digital assets can be released to the users' crypto wallet from the subnet smart contracts. The native coin of the subnet is the exception as it is also used as the gas token to pay for the gas.

As used herein, the term “blockchain” generally refers to an open and distributed public ledger comprising a growing list of records, which are linked using cryptography. By design, the blockchain is resistant to modification of the data. The blockchain can include an auditable database that provides a distributed, replicated ledger of cryptographically certified artifacts whose contents are extremely difficult to tamper with without detection, and therefore, are with very high probability, true copies of the intended content, and whose content are open for inspection via a suitable query interface.

As used herein, the term “block” generally refers to a record that is kept in a blockchain. For example, each block contains a cryptographic hash of the previous block, a timestamp, and transaction data, which can generally be represented as a Merkle tree root hash.

As used herein, the term “subnet” or “subnetwork” generally refers to a dynamic set of validators working together to achieve consensus on a state of a set of blockchains. For example, each blockchain is validated by exactly one subnet. A subnet can validate arbitrarily many blockchains. A validator node may be a member of arbitrarily many subnets. A subnet may manage its own membership and it may require that its constituent validators have certain properties.

### Example Architecture

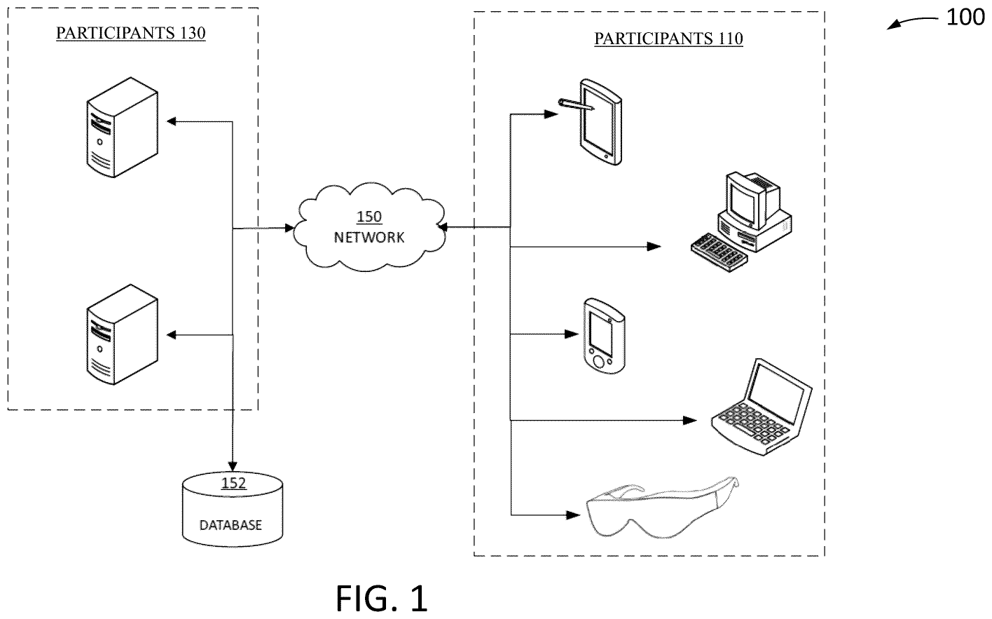

FIG. 1 illustrates an exemplary network architecture 100 to provide a blockchain platform (e.g., blockchain network implementation/deployment platform) used to facilitate multi chain trading, according to some embodiments. Blockchains in the blockchain network are validated by (i.e., the state of it is maintained by) a group of nodes. The group of nodes is called a subnet. As such, the blockchain platform includes subnets with corresponding validator sets.

The blockchain may be a linear chain of blocks of the same dimension, such as the same height, size, length, etc. Blocks of the blockchain may comprise or store data or organized information (e.g., records of information), including a cryptographic hash of the previous block, a timestamp, and transaction data, for example. The network architecture 100 of FIG. 1 includes one or more participants 110 and one or more participants 130 which are communicatively coupled through the network 150. The blockchain architecture of the network architecture 100 can be a distributed database that maintains a continuously growing list of ordered records as the blocks.

The network architecture 100 may implement multi-blockchain trading using messaging (e.g., a messaging protocol) between blockchains, subnets, and/or combinations thereof. It is understood that the participants 130 may include the participants 110 as well, such that they are peers. As an example, the participants 130 may include a cloud server or a group of cloud servers. In some implementations, the participants 130 may not be cloud-based servers (i.e., may be implemented outside of a cloud computing environment) or may be partially cloud-based. The participants 130 may include one or more desktop computers or panels mounted on racks, and/or the like. The panels may include processing boards and also switchboards, routers, and other network devices. Multiple participants 110 may have access to the blockchain platform hosted by the participants 130 via an online or offline connection, such as a wireless connection, wired connection, ad hoc connection, mobile connection, satellite connection, and/or the like.

The participants 110 may include any one of a laptop computer, a desktop computer, or a mobile device such as a smart phone, a palm device, or a tablet device. As an example, the participants 110 may be clients of the blockchain platform for creating, expanding, or otherwise modifying customized blockchain networks and/or private or public subnets using cryptocurrency wallets. The participants 110 can function as validators. For example, the participants 110 can be controlled by users as a set of validator nodes for making decisions in tandem, such as for facilitating operation or design of the blockchain implementations of the blockchain platform. The participants 110 may be virtual machines (VMs) that form nodes of the blockchain network architecture 100, nodes that can run software to verify block and transaction data, store data, validate, respond to network requests for data, and/or the like for the existing blockchain. The VMs can be computers that run on blockchain and allow smart contracts from multiple sources to interact with one another. The participants 110 send messages or issue transactions upon request by the participants 130, such as via a module of the participants 130 at a particular time. The messages may be validated by a validator of the blockchain network.

The network 150 may include a wired network (e.g., via fiber optic or copper wire, telephone lines, and the like) or wireless network (e.g., a cellular network, radio-frequency (RF) network, Wi-Fi, Bluetooth, and the like).

The network architecture 100 may store data of the existing blockchain or subnet in a peer-to-peer (P2P) and/or distributed ledger fashion in database 152. The database 152 may store relevant information regarding, for example, execution, verification logic and/or rules for implementing messaging protocols, etc. The participants 130 may be configured to implement multiple chains of the blockchain network architecture 100. For example, the participants 130 can implement token deposit, withdrawal, transfer and swapping (trading) of blockchain assets in a plurality of chains of the blockchain network architecture 100, such as an asset blockchain (e.g., for creating new assets, asset exchange, cross-subnet transfers), metadata blockchain (e.g., for coordinating validators, tracking active subnets, and creating new subnets), smart contract blockchain (e.g., for creating smart contracts and applications that require total ordering), etc.

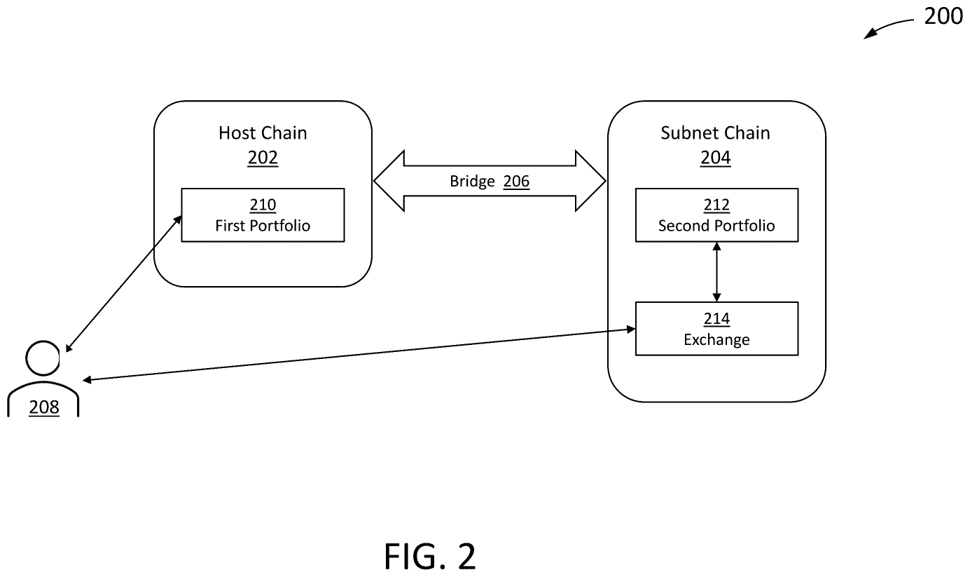

FIG. 2 illustrates a trading workflow 200 of a multi-chain application existing on a deposit/host chain 202 (e.g., the host blockchain), and a subnet chain 204 (e.g., the target blockchain, or subnet). The host chain 202 and the subnet chain 204 may communicate by generic messages serviced by a bridge 206. The bridge 206 may include a third-party bridge application configured for transferring generic messages. The bridge 206 may not be responsible for bringing tokens. According to embodiments, the multi-chain application allows interactions between multiple host blockchains all sending their flows into the subnet.

As shown in FIG. 2, a user 208 may deposit an asset or token from a crypto wallet corresponding to the user 208 into a first portfolio 210 of the host chain 202. The portfolio 210 may include a smart contract and a list of assets. The asset or token, after being deposited, is locked in the first portfolio 210. In response to the deposit, a generic message is sent to a second portfolio 212 of the subnet chain 204 via the bridge 206. The message may comprise specifics of the asset in this current transaction. For example, the message may include, but is not limited to, nonce, transaction type, user address, chain identification (ID), token symbol, quantity, and timestamp. The message is received by the subnet chain 204. The subnet chain 204 identifies the user's address from the message and credits the user for the asset.

According to some embodiments, the user 208 may request to withdraw an asset from the host chain 202 and deposit to the subnet chain 204. In response to the request, the subnet chain 204 may send a message to the host chain 202 via the bridge 206. The message may include specifics of the requested asset. Subsequently, the amount of the withdrawal is unlocked from the first portfolio 210 and released to the crypto wallet of the user 208 in the host chain 202. As such, the locked balance of tokens/assets in the first portfolio 210 of the host chain 202 is reduced by an equal amount to the amount released from the second portfolio 212 of the subnet chain 204.

The user 208 may request to exchange, via exchange 214, assets with one or more other assets that are deemed tradable by the subnet chain 204. An administrator of the subnet chain 204 may define what constitutes as tradable based on the asset. In this manner, the sum of assets in the host chain 202 will remain equal to the sum of the assets in the subnet chain 204.

In some embodiments, the user 208 may enter an order or initiate a cancel order from the crypto wallet to the host chain 202 or the subnet chain 204.

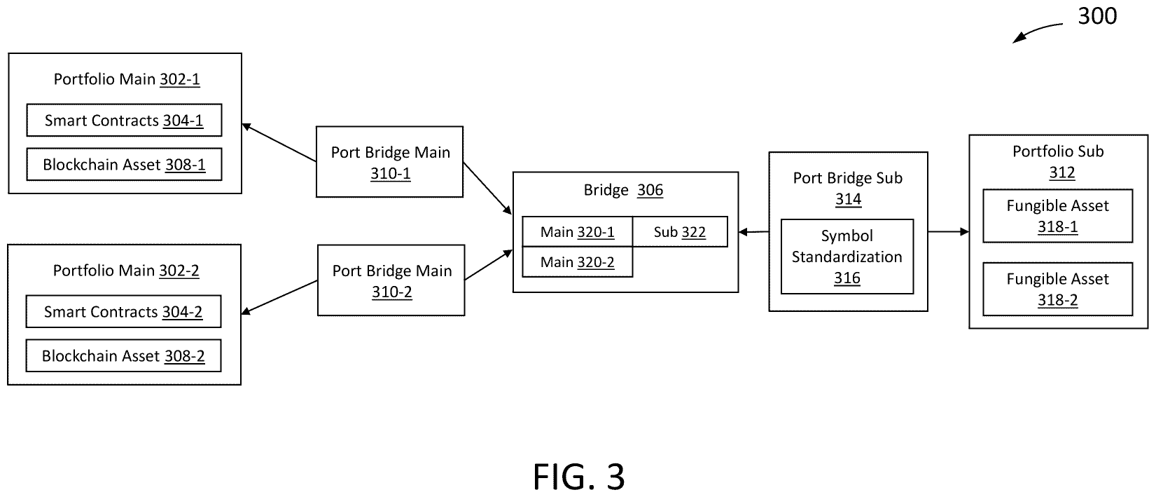

FIG. 3 is a block diagram 300 illustrating components in a network including multiple host blockchains linked to a subnet hosting multiple users via a bridge application (e.g., bridge 306). As shown in FIG. 3, the host blockchains include portfolio main 302-1 (referred to as “PortfolioMain 1”), portfolio main 302-2 (referred to as “PortfolioMain 2”), and portfolio main n (not depicted). The portfolio main 302-1 and portfolio main 302-2 may be implementing or based on smart contracts 304-1 and smart contracts 304-2, respectively. The subnet holds a portfolio sub 312 (referred to as “PortfolioSub”) of fungible assets 318-1 and 318-2 for each user. Blockchain asset 308-1 and blockchain asset 308-2 may be traded, deposited, or withdrawn, as described according to embodiments, using generic messages. The information flow for messages between PortfolioMain 1 and PortfolioMain 2 and PortfolioSub may be as follows:
PortfolioMain (1/2/n)=>PortfolioBridgeMain (1/2/n)=>BridgeProvider (1/2/n)=>PortfolioBridgeSub=>PortfolioSub
PortfolioSub=>PortfolioBridgeSub=>BridgeProvider 1/2/n=>PortfolioBridgeMain (1/2/n)=>PortfolioMain (1/2/n)

where PortfolioMain (1/2/n) corresponds to portfolio main 302-1, portfolio main 302-2, and portfolio main n, respectively, PortfolioBridgeSub corresponds to port bridge sub 314, PortfolioSub corresponds to portfolio sub 312, PortfolioBridgeMain (1/2/n) corresponds to port bridge main 310-1, 310-2, 310-n, respectively, and BridgeProvider1/2/n corresponds to bridge 306.

The PortfolioBridgeMain 1/2/n may be the bridge aggregator that relays messages to/from the host blockchain and is bridge-agnostic. For example, PortfolioBridgeMain 1 (port bridge main 310-1) relays to/from portfolio main 302-1 and main 320-1, PortfolioBridgeMain 2 (port bridge main 310-2) relays to/from portfolio main 302-2 and main 320-2, and

PortfolioBridgeMain n relays to/from main n, in the case of n host blockchains. The bridge 306 may be a third-party application. In some embodiments, one or more bridges (e.g., bridge 1 and bridge 2, . . . bridge n) may connect the one or more host blockchains with one or more subnets.

The port bridge sub 314 may include a bridge aggregator that relays messages to/from the subnet and is bridge-agnostic. For example, port bridge sub 314 may relay messages to/from portfolio sub 312 and sub 322. In some embodiments, the port bridge sub 314 may be a liquidity aggregator including a list of assets from multiple blockchains. Subnet admins may create an internal list of assets from multiple blockchains in the exchange (e.g., tokenDetailsMapById and tokenDetailsMapBySymbolChainId) that provides symbol standardization and commingling. The list keeps track of asset details and an inventory from each chain independently using a host chain ID sent in the message. By non-limiting example, the symbol is mapped as SYMBOL+host Chain ID when a deposit message is received in the subnet. This list is updated as necessary by the subnet admins.

According to embodiments, the symbol standardization 316 may map the symbol in a message received from a host chain (e.g., PortfolioBridgeMain (1/2/n)) into a shared subnet symbol. By non-limiting example, a token or asset having a symbol BTC.b43114, associated with an asset minted in a first blockchain with chain ID 43114, is mapped to BTC. Similarly, WBTC, associated with an asset minted in a second blockchain with chain ID 1, can also be mapped to BTC if feasible, by the admins (e.g., if minted by the same entity in both host blockchains). In this manner, liquidity can be combined, and different versions of the same asset are traded together as one in a multichain implementation. When sending the asset back to the target chain (e.g., withdrawal from the subnet), the PortfolioBridgeSub maps the asset back to the expected symbol by the host chain, e.g., BTC is mapped to WBTC if sent back to the second blockchain, BTC.b if sent back to the first blockchain. The commingling of assets is recorded securely by the port bridge sub 314.

Introducing a new host blockchain into the application brings additional inventory management challenges when withdrawing from the subnet to one of the host blockchains. The port bridge sub 314 is fully aware of the inventory held in each host chain. Accordingly, the port bridge sub 314 may implement financial incentives to encourage users to withdraw to the host blockchain with highest inventory using an inventory manager contract. In some implementations, the port bridge sub 314 may impose fees to discourage users to withdraw assets to the host chains with lower inventory, helping to facilitate inventory management.

In some embodiments, the bridge 306 (and similarly, bridge 206) may include a third-party bridge application using Layer Zero, providing an initial setup where both the PortfolioBridgeMain (1/2n) and the PortfolioBridgeSub are securely tied and only transmit messages amongst each other. Layer Zero includes security protocols to make sure the messages have a guaranteed delivery, are delivered in sequence (without skipping a nonce) and remain immutable while they are being transmitted.

Users can connect their crypto wallets with smart contracts to have their token deposited into the PortfolioMain and have the same amount of fungible tokens reflected in their subnet account (portfolio sub 312). As users trade and interact with the subnet smart contracts using their crypto wallets, the portfolio sub 312 keeps track of the users' current balances for all tokens at all times. Trades settle instantly within portfolio sub 312 amongst all involved parties.

In some embodiments, the subnet includes a fungible asset stock (gas token) to pay for transactions (e.g., fungible assets 318-1 and 318-2), which is the same as the native coin assigned to the subnet. The crypto wallets of every user in the subnet should have some gas tokens to pay for state changing transactions (e.g., send order, cancel order, transfer token to a different address, withdraw). According to embodiments, the gas token may be the only token that can exist outside the subnet smart contracts. Gas tokens can move back and forth between a user's wallet and the subnet smart contracts and other tokens can only exist in the subnet smart contracts.

According to embodiments, an auto-fill procedure deposits a small amount of gas tokens in users' subnet wallets in exchange for a token deposited in the users' address from the host blockchain. The token deposited in the users' address from the host blockchain may be any token including, but not limited to, the gas token. Hence, initiating a token deposit from any source blockchain guarantees having gas tokens in the user subnet's wallet, enabling him to continue issuing transactions in the subnet without any additional steps. The wallet's gas token balance management is facilitated by the auto-fill function, processing in the background, seamless to the user and subsequent to any state changing transaction issued by the user. The auto-fill function avoids the situation of users having zero gas tokens in their subnet crypto wallet, which would in turn stop them from issuing any transactions in the subnet.

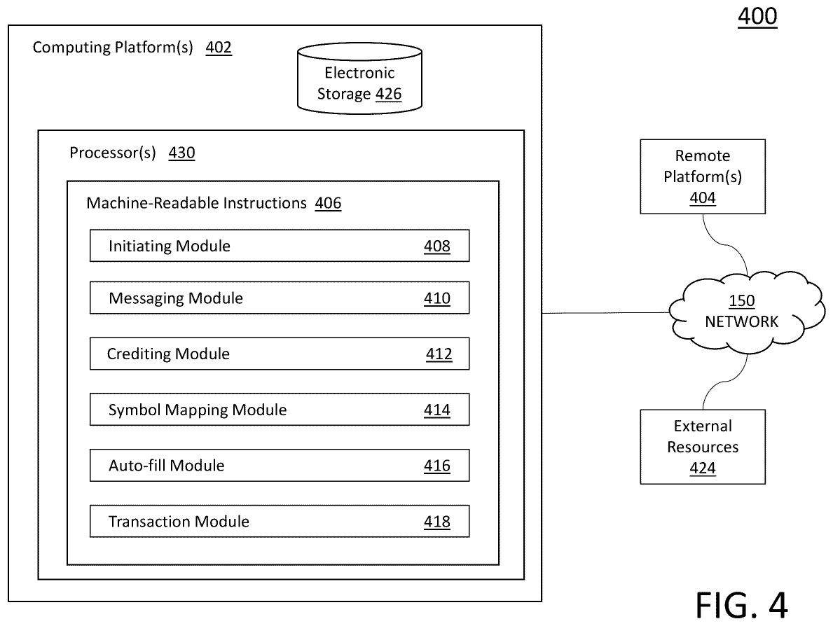

FIG. 4 is a block diagram illustrating an example blockchain asset management system 400 with which aspects of the subject technology can be implemented. The system 400 may be configured for processing a token transaction between a host blockchain and a subnet, according to certain aspects of the disclosure. The system 400 may include a blockchain platform managing blockchains, subnets, and/or smart contracts. The system 400 may include a user wallet including a fungible stock of user assets that the user can access to perform blockchain transactions. The system 400 may include a network server having a copy of a transaction ledger that is updated with a transaction of a user in a blockchain network. In some implementations, the system 400 may include one or more computing platforms 402. The computing platform(s) 402 can correspond to a server component of the blockchain platform, which can be similar to or the same as the computing device(s) of participant 130 of FIG. 1 and include the client computing device(s) of participant 110 of FIG. 1.

Computing platform(s) 402 can be configured to implement messaging protocols enabling the transfer of messages from the client computing device(s). The computing platform(s) 402 may represent blockchain platforms. In some embodiments, the computing platform(s) 402 corresponds to a blockchain or subnet creating a message or receiving a message. The computing platform(s) 402 may be configured to execute a message plugin configured to access messages between multiple blockchains in the blockchain network to update an asset stock for a user in each blockchain. The computing platform(s) 402 may be configured to communicate with one or more remote platforms 404 according to a client/server architecture, a peer-to-peer architecture, and/or other architectures. The remote platform(s) 404 may be configured to communicate with other remote platforms via computing platform(s) 402 and/or according to a client/server architecture, a peer-to-peer architecture, and/or other architectures. The computing platform(s) 402, external resources 424, and remote platform(s) 404 may be in communication and/or mutually accessible via the network 150.

The computing platform(s) 402 may be configured by machine-readable instructions 406. The machine-readable instructions 406 may be executed by the computing platform(s) to implement one or more instruction modules. The instruction modules may include computer program modules. The instruction modules being implemented may include one or more of initiating module 408, messaging module 410, crediting module 412, symbol mapping module 414, auto-fill module 416, transaction module 418 and/or other instruction modules.

The initiating module 408 may be configured to receive a request from a user. The request may be for a token deposit, withdrawal, cancel order, or the like. The initiating module 408 may be further configured to, in response to the request, initiate a transaction. By non-limiting example, the initiating module 408 may initiate a token deposit in a host blockchain based on a smart contract. By non-limiting example, the initiating module 408 may initiate a token withdrawal in a subnet blockchain based on a smart contract. The messaging module 410 may be configured to generate a message including one or more details of the token based on the request (e.g., a token deposit or withdrawal). The messaging module 410 may be further configured to transmit the message, using a bridge application, to a smart contract counterpart in a target blockchain or subnet. The message may provide specifics of the transaction including, but not limited to, nonce, transaction type, user address, token symbol, quantity, timestamp, and custom data. The smart contract counterpart receives the message generated by the messaging module 410.

The crediting module 412 may be configured to credit an address of the user based on the message. For example, the host blockchain may be credited based on the host ID included in the message. The crediting module 412 may update the user's balances on the host blockchain, the target blockchain, and/or the crypto balance for the user in their crypto wallet. The crediting module 412 may be responsible for ensuring that all subnet smart contracts mirror balances from all the host blockchains' smart contracts. The crediting module 412 may also take into account current deposit/withdraw messages still being processed by the messaging module 410.

The symbol mapping module 414 may be configured to identify a symbol and one or more other details of the transaction and maps the symbol to another asset expected asset symbol. By non-limiting example, symbol mapping module 414 may standardize and map a host chain symbol to a subnet symbol that is shared across all host chains. The mappings for each transaction in the network may be stored in a list of assets from multiple blockchains, tracking asset details and inventory from each chain. By non-limiting example, the symbol mapping module 414 maps the symbol as SYMBOL+host ChainID when a deposit message is received in the target blockchain. The symbol mapping module 414 may map symbols in a message received from a host blockchain into a shared subnet symbol. Symbols from two different host blockchains mapped to the same shared subnet symbol can be traded as one.

The auto-fill module 416 may be configured to deposit a predetermined (small) amount of gas tokens for the user when the gas token for the user falls below a predetermined threshold. The deposit may be in exchange for a small portion of the token deposited by the user. In some implementations, the auto-fill module 416 may be configured to add gas tokens when the user's crypto wallet gas token has zero balance.

According to embodiments, the auto-fill module 416 may be further configured to execute a swap from a different token type when there is not enough gas tokens in a user subnet smart contract balance. In some embodiments, the user may request to swap one or more assets in their crypto wallet. In this instance, the auto-fill module 416 may be further configured to auto-fill the user's crypto wallet with gas tokens upon receiving an asset swap request from the user. In some embodiments, the user may request to cancel an asset swap request. In this instance, the auto-fill module 416 may be further configured to auto-fill the user's crypto wallet with gas tokens upon receiving a cancel request for an asset swap.

According to embodiments, the auto-fill module 416 is not limited to deposit transactions from host chains. In some embodiments, the auto-fill module 416 may be further configured to autofill during transfers from one user account to another user's account within the subnet. When a token transfer is initiated within the subnet smart contracts, the receiving user's wallet can be auto-filled with gas tokens if the receiving user's gas token balance is not sufficient.

The transaction module 418 may be configured to execute the transaction with, for example, subnet smart contracts using the crypto wallet and paying the gas fees associated with the transaction. Executing the transaction may include encoding, in the host blockchain, a record of the token deposit or withdrawal in the host blockchain. In some embodiments, executing the transaction may include paying a message fee to the bridging application facilitating the message transfer between the host blockchain and the target blockchain/subnet.

In some implementations, the computing platform(s) 402, the remote platform(s) 404, and/or the external resources 424 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 402, the remote platform(s) 404, and/or the external resources 424 may be operatively linked via some other communication media.

A given remote platform 404 may include client computing devices, which may each include one or more processors configured to execute computer program modules. The computer program modules may be configured to enable an expert or user associated with the given remote platform 404 to interface with the system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms. The external resources 424 may include sources of information outside of the system 400, external entities participating with the system 400, and/or other resources. For example, the external resources 424 may include externally designed blockchain elements and/or applications designed by third parties. In some implementations, some or all of the functionality attributed herein to the external resources 424 may be provided by resources included in system 400.

Computing platform(s) 402 may include the electronic storage 426, a processor such as the processors 430, and/or other components. The computing platform(s) 402 may include communication lines, or ports to enable the exchange of information with a network and/or other computing platforms. Illustration of the computing platform(s) 402 in FIG. 4 is not intended to be limiting. The computing platform(s) 402 may include a plurality of hardware, software, and/or firmware components operating together to provide the functionality attributed herein to the computing platform(s) 402. For example, the computing platform(s) 402 may be implemented by a cloud of computing platforms operating together as the computing platform(s) 402.

Electronic storage 426 may include non-transitory storage media that electronically stores information. The electronic storage media of the electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426 may include one or more virtual storage resources (e.g., cloud storage, a virtual private network, and/or other virtual storage resources). Electronic storage 426 may store software algorithms, information determined by the processors 430, information received from computing platform(s) 402, information received from the remote platform(s) 404, and/or other information that enables the computing platform(s) 402 to function as described herein.

Processor(s) 430 may be configured to provide information processing capabilities in computing platform(s) 402. As such, processor(s) 430 may include one or more of a digital processor, an analog processor, a digital circuit designed to process information, an analog circuit designed to process information, a state machine, and/or other mechanisms for electronically processing information. Although processor(s) 430 is shown in FIG. 4 as a single entity, this is for illustrative purposes only. In some implementations, processor(s) 430 may include a plurality of processing units. These processing units may be physically located within the same device, or processor(s) 430 may represent processing functionality of a plurality of devices operating in coordination. Processor(s) 430 may be configured to execute modules 408, 410, 412, 414, 416, and/or 418, and/or other modules. Processor(s) 430 may be configured to execute modules 408, 410, 412, 414, 416, and/or 418, and/or other modules by software; hardware; firmware; some combination of software, hardware, and/or firmware; and/or other mechanisms for configuring processing capabilities on processor(s) 430. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, and/or 418 are illustrated in FIG. 4 as being implemented within a single processing unit, in implementations in which processor(s) 430 includes multiple processing units, one or more of modules 408, 410, 412, 414, 416, and/or 418 may be implemented remotely from the other modules. The description of the functionality provided by the different modules 408, 410, 412, 414, 416, and/or 418 described below is for illustrative purposes, and is not intended to be limiting, as any of modules 408, 410, 412, 414, 416, and/or 418 may provide more or less functionality than is described. For example, one or more of modules 408, 410, 412, 414, 416, and/or 418 may be eliminated, and some or all of its functionality may be provided by other ones of modules 408, 410, 412, 414, 416, and/or 418. As another example, processor(s) 430 may be configured to execute one or more additional modules that may perform some or all of the functionality attributed below to one of modules 408, 410, 412, 414, 416, and/or 418.

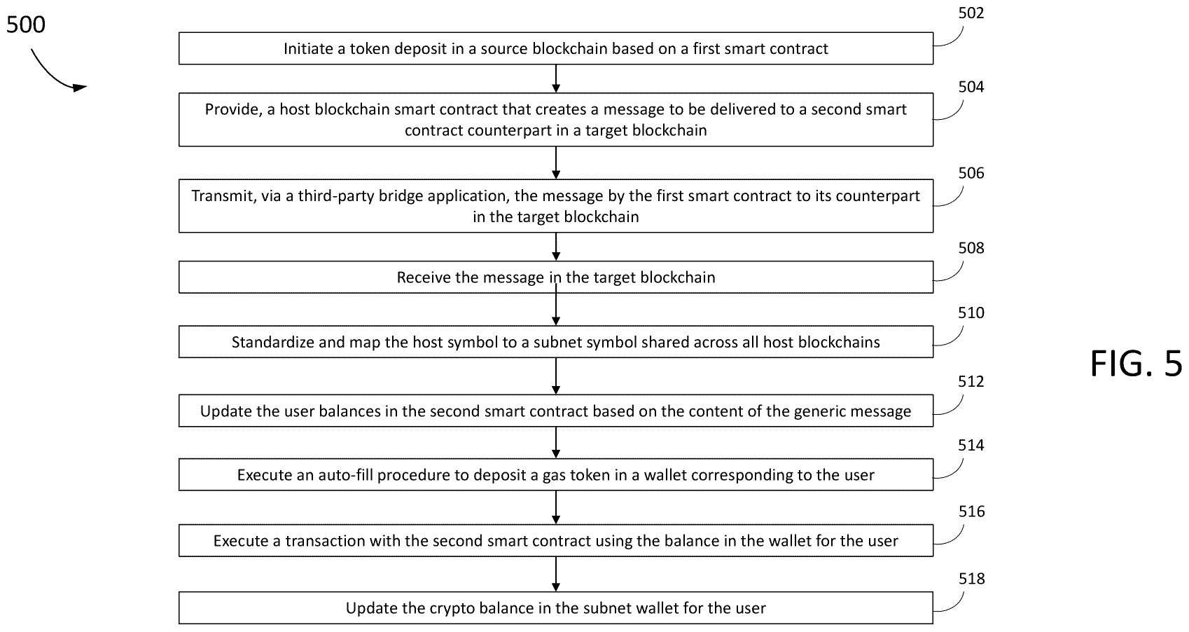

FIG. 5 illustrates an example flow diagram of a process 500 for a token transaction between a host blockchain and a target blockchain, according to certain aspects of embodiments. For explanatory purposes, the steps of the example process 500 are described herein as occurring in serial, or linearly. However, multiple instances of the example process 500 may occur in parallel, overlapping in time, almost simultaneously, or in a different order from the order illustrated in the process 500.

Step 502 includes initiating a token deposit in a host blockchain based on a first smart contract. In some embodiments, users deposit their token into the first smart contract (e.g., in first portfolio 210) in their originating/host chain (e.g., host chain 202). According to embodiments, the process 500 may further include locking the token deposit in the first smart contract, such that they remain within their host blockchain. Step 502 may include generating, at the host blockchain, a token representation including a host symbol for the token deposit and a host ID of the token deposit.

Step 504 includes creating, at the host blockchain, a message that includes one or more details of the token deposit to be delivered to a second smart contract in a target blockchain (e.g., subnet chain 204). For example, the message may include a host symbol and host ID. The target blockchain may include one or more subnet smart contracts (e.g., the second smart contract). The message may be a generic message generated using, for example, a blockchain messaging protocol. In some embodiments, step 504 includes automatically providing a message to be delivered to the second smart contract in the target blockchain. The one or more details of the token deposit may include nonce, transaction type, user address, token symbol, a host chain ID, quantity, block timestamp, and a custom field. In some embodiments, a unique nonce is provided to each message transmitted between the host blockchain and the target blockchain counterpart (e.g., second smart contract). In some embodiments, the host blockchain smart contracts and the target blockchain counterpart only send messages to each other.

Step 506 includes transmitting, via a third-party bridge application, the message by the first smart contract in the host blockchain to its counterpart (i.e., second smart contract) in the target blockchain. In embodiments, the first smart contract and the second smart contract may be subnet smart contracts of the respective blockchains and/or subnets. In some embodiments, when a withdrawal request is made, the process 500 may include receiving, using the bridge, a message from a smart contract counterpart of a transaction for a blockchain asset, the message including details of the blockchain asset. The bridge application includes security protocols to make sure the messages have guaranteed delivery, are delivered in sequence (e.g., without skipping a nonce) and remain immutable while they are being transmitted. In some embodiments, if a bridge fee is set for the token, it is deducted before it is sent out to the main port in the bridge.

Step 508 includes receiving the message in the target blockchain. The first smart contract's counterpart (i.e., the second smart contracts) of a transaction for a blockchain asset may receive the message. The message is processed by the second smart contracts in the target subnet. In some embodiments, a list of tokens is maintained in a third smart contract of the bridge (e.g., port bridge sub 314). The list of tokens may contain all the tokens from all the host blockchains. In some implementations, the list of tokens may also contain all the details of the token such as a host symbol, a host address, token/VM decimals, etc. For example, a list of tokens comprising a list of blockchain assets may include an associated symbol and a host blockchain for each blockchain asset and the list of blockchain assets may be updated in real time.

At step 510, the host symbol is standardized and mapped to a subnet symbol that is shared across all host blockchains (e.g., WEHT.e from bc1 and WETH from bc2, share the same ETH as the subnet symbol).

In some embodiments, the process 500 includes performing inventory management. By non-limiting example, the port bridge sub 314 knows about every deposited and withdrawn quantity for each token and keeps track of the current balances of each host blockchain independently to allow inventory management incentives at the time of withdrawal. The inventory management keeps track of balances of blockchain assets across multiple blockchains based on the transaction for the blockchain asset. This ensures that the withdrawal request will not fail at the target host chain because the quantity available at the target is already known and user won't be allowed if quantity requested is larger than what's available.

By non-limiting example, a map USDC43114 is created when a token USDC is from a host blockchain with chain ID 43114. And a map USDC1 is created if token USDC is from a second host blockchain with chain ID: 1. This enables multichain symbol handling for the target blockchain to differentiate host blockchains for the token.

Step 512 includes updating the user's balances in the target blockchain (e.g., in the smart contract) based on the content of the message. Updating the user's balances may further include crediting the smart contract balances of the host blockchain with the details of the deposit (e.g., a token amount) according to the message. As such, balances known by the subnet smart contracts should be equal to the balances locked in the host blockchain smart contracts (i.e., first smart contract) that sent the message.

Step 514 includes executing an auto-fill procedure to deposit small amounts of gas tokens (e.g., ALOT) in a crypto wallet corresponding to the user in exchange for a small portion of tokens deposited by the user. According to embodiments, the small portion of tokens can be any token including the gas token itself. The auto-fill procedure may automatically fill the user's crypto wallet with additional gas tokens if their balance goes below a threshold as they continue to interact with subnet smart contracts in a network.

Step 516 includes executing one or more transactions with the second smart contract in the target blockchain using the crypto wallet and paying the gas fees associated with this transaction. In some embodiments, executing the transaction may include swapping one crypto currency with another of equal value, providing token swap functionality to the user with subnet smart contracts.

Step 518 includes updating the crypto balance for the user in the second smart contracts (e.g., in Portfolio Sub 312) by the token amounts swapped. The updates are made in real time as the user continues to issue transactions. Associated gas fees are automatically deducted from the users' crypto wallet by the blockchain protocol.

The techniques described in, for example, process 500 may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIG. 5 may be performed by a processor circuit executing instructions stored in a memory circuit, in a client device, a remote server or a database, communicatively coupled through a network (e.g., processor(s) 430, machine-readable instructions 406, participants 110, participants 130, database(s) 152, and network 150).

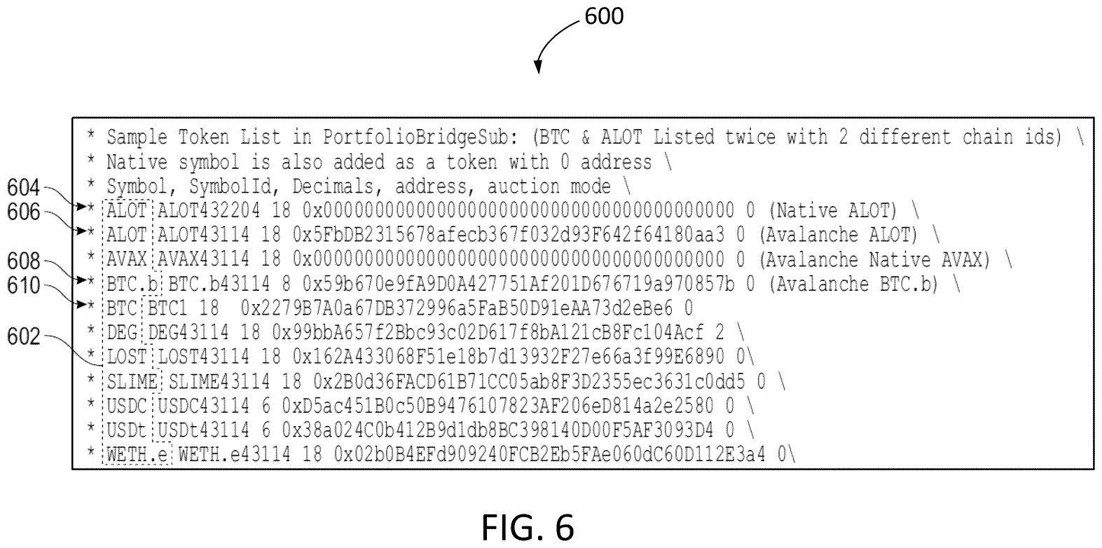

FIG. 6 illustrates a sample token list 600 in the third smart contract (e.g., port bridge sub 314). According to embodiments, the third smart contract of the bridge receives the message sent by the bridge and maps token symbols to both the symbol and host chain ID (i.e., “symbol+host chain ID”) and to the shared symbol, as shown in the first column 602 in FIG. 6. According to embodiments, the token symbols are unique identifiers of token type.

A native symbol may also be added as a token with zero (0) address, by non-limiting example, native ALOT 604 and native AVAX 606. Each token in the sample token list may include, but is not limited to, a corresponding symbol, symbol ID, decimals, address, and auction mode. The shared symbol denotes the symbol to be used in the target blockchain and is the symbol that is visible to the user.

According to embodiments, if symbols from two different host blockchains are mapped to the same shared symbol, they will be traded as one in the target blockchain. Steps according to processes (e.g., process 500) and methods of embodiments may include resolving the shared trading symbol of a symbol of a deposited token. In some embodiments, a list of shareable symbols is predetermined. By non-limiting example, a native ALOT432204 in a subnet (first in the symbol list), and ALOT43114 from a first host blockchain (second in the symbol list) will be traded as one and its shared symbol will be ALOT. As such, blockchain assets sharing the same symbol are treated as a single asset.

According to some embodiments, inventory management tasks are performed to incentivize users to withdraw a shared token to a host blockchain having a highest inventory of the shared token and de-incentivizing users to withdraw a shared token to a host blockchain having a lower inventory of the shared token.

As another non-limiting example, BTC.b43114 from the first host blockchain (row 608) will be traded as a separate token from BTC1 from a second host blockchain (row 610) because the symbol columns show different values (i.e., BTC.b and BTC, respectively). Had they both been BTC, the tokens could have been traded as one. These settings are handled by, for example, target blockchains or subnet admins.

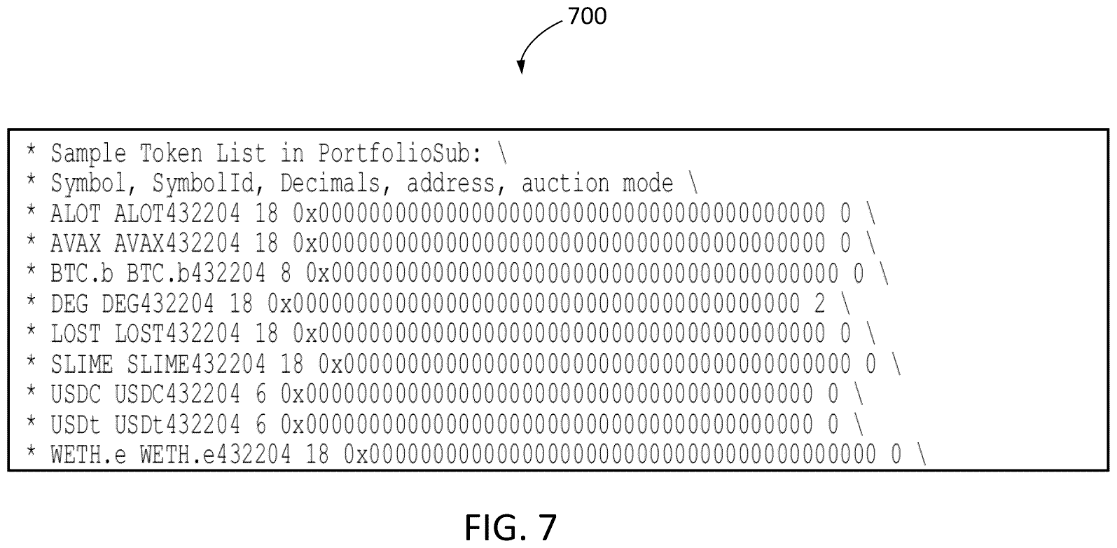

FIG. 7 illustrates a list of tokens (shared symbols) 700 in a subnet (e.g., Portfolio Sub 312). The host blockchains may be unknown to this smart contract and thus the tokens only have the subnet identifier 432204 next to the type of symbol (e.g., ALOT, AVAX, DEG, LOST, SLIME, USDC, USDt, and WETH.e). The symbol column as shown in FIG. 7 includes a shared subnet symbol. Tokens in the subnet have zero (0) address because of the lack of fungible token smart contracts in the subnet. This is in contrast to the tokens in the port bridge sub 314 of the bridge in FIG. 3, which have the proper addresses of each token from each host blockchain, for reference.

According to some embodiments, subnet smart contracts mirror balances from all the host blockchains' smart contracts and can be used for sanity check by an off-chain application. Accordingly, host blockchains' balances should be equal to subnet balances at all times, taking into consideration the deposit/withdraw messages that are in-flight (i.e., still being processed inside the third-party bridge application) between the host blockchains and the subnet. This mechanism provides an additional check to protect against hacks, exploits, and fraud.

In some embodiments, the auto-fill command may execute a swap from a different token type when there is not enough gas tokens in a user subnet smart contract balance. Swap rates may be set by an off-chain application using market rates. By non-limiting example, given a swap rate of 1 ALOT is equal to 0.20 USDT, or 0.1 ALOT is equal to 0.02 USDT, when 10 USDT asset stock in a source blockchain is deposited, the asset stock in the subnet for the user will reflect 9.98 USDT and there will be 0.1 ALOT in the wallet.

In some embodiments, the auto-fill command may be triggered when the gas token for the user falls below a predetermined threshold (e.g., 50% of its original default value: 0.1 ALOT). This eliminates the additional manual steps to buy gas tokens from the market and then deposit in their wallet. In some embodiments, auto-fill may be triggered when one of the following actions are taken: deposits from a source blockchain, sending funds from one user address to another within the smart contracts, sending new orders, and/or canceling orders or any other state changing transaction within the smart contracts.

In some embodiments, the auto-fill command always deposits the default amount of gas tokens without any token in return, if it is an initial token deposit at the source blockchain and if the user has a 0 gas token balance in his subnet wallet. This is true even when the deposited token may not have any market value as it may not have started trading yet, hence disqualifying it for swapping. In some embodiments, the auto-fill command may execute whenever the user is issuing a state changing transaction in the subnet/target blockchain.

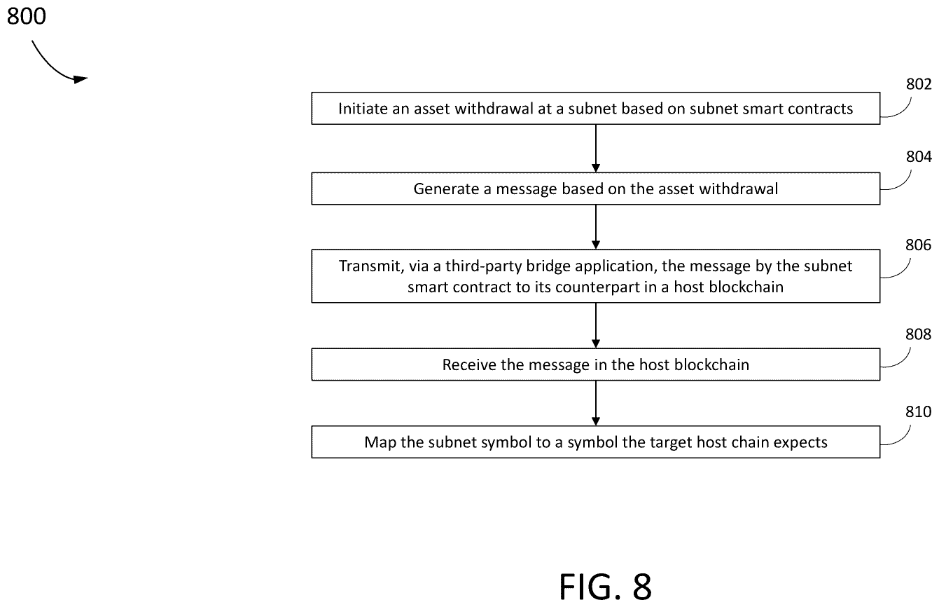

FIG. 8 is a flowchart illustrating steps in a method 800 for withdrawing an asset held by a user in a subnet, according to some embodiments. Any user can, at any point in time, withdraw their holdings from the subnet. By non-limiting example, the user may withdraw their holdings by initiating a withdraw to a host blockchain command. In the command, the user must specify the host blockchain and pay the appropriate bridge fee calculated automatically by the smart contracts based on inventory at the selected host blockchain.

In the method 800, the sequence of steps may be described as follows: PortfolioSub (e.g., portfolio sub 312) calls PortfolioBridgeSub (e.g., port bridge sub 314) with the withdrawal details, symbol, quantity, and others. PortfolioBridgeSub and InventoryManager calculates the bridge fee and maps the symbol that the host blockchain expects. A bridge application transmits the message to the host blockchain's PortfolioBridgeMain (e.g., port bridge main 310-1, 310-2). PortfolioBridgeMain calls PortfolioMain (e.g., portfolio Main 302-1, 302-2) for the amount to be unlocked and released to the user's crypto wallet.

Step 802 includes initiating, upon request by a user from a subnet, an asset (or token) withdrawal based on an asset symbol appearing in an asset listing for the user in the subnet. In some embodiments, the user picks the host blockchain to withdraw the asset to. In some embodiments, step 802 includes communicating, to the user, the bridging fee, prior to requesting the host blockchain to release the withdrawal amount of the asset. In some embodiments, the subnet blockchain may only interface with its counterpart smart contracts originating from selected host blockchains.

According to embodiments, the method 800 may further include queueing the asset withdrawal when a stock of the asset at the host blockchains has an insufficient inventory. If the user insists on withdrawing to a host blockchain that does not have enough inventory to cover the withdrawal, the request is queued for a selected period of time (e.g., a few hours) and the subnet admins will provide the required amount to the host blockchain's smart contracts for the withdrawal to go through successfully.

In some embodiments, step 802 may further include mapping, at the subnet blockchain, a subnet symbol for the token withdrawn and the host ID of the host blockchain selected by the user. The method 800 may further include debiting the user's subnet balances by the amount of token withdrawal to be used in inventory management.

Step 804 includes generating a message via a third-party bridge application corresponding to the asset withdrawal. The message may include nonce, a transaction type, a user address, a token symbol, a quantity (withdrawal amount), host chain ID, a block time stamp, and custom data. In some embodiments, the third-party bridge application transmits a generic message to be delivered to the host blockchain smart contracts (PortfolioBridgeMain). In some embodiments, step 804 includes, in the subnet smart contracts, reverse-mapping the shared symbol to the symbol the host blockchain ID expects. In some embodiments, the token withdrawn decreases the subnet blockchain balances of the host chain to enable proper inventory management.

Accordingly, at the time of a withdrawal, the subnet smart contracts guide users to withdraw tokens to the host blockchain that has the highest asset inventory (e.g., by lowering or eliminating transaction fees for the user) and discourage withdrawing tokens to a host blockchain that has the lowest inventory (e.g., by increasing or charging extra transaction fees). By non-limiting example, USDT1 and USDt43114 is traded as one under “shared subnet symbol” USDT. Consider the first host blockchain holding 800 USDT and the second host blockchain holding 200 USDT, the subnet smart contracts may suggest 0 bridge fees for the first host blockchain and, for example, ˜40 USDT bridge fees for the second host blockchain to users who want to withdraw 100 of their USDT tokens. In some embodiments, the method 800 may include providing a list of host blockchains and their associated withdrawal fees (bridge fees) where the users can withdraw their assets when desired.

Step 806 includes a third-party bridge application that transmits the message by the subnet (e.g., the subnet smart contracts) to the smart contract's counterparts in the host blockchain. The bridge application includes security protocols to make sure the messages have guaranteed delivery, are delivered in sequence (without skipping a nonce), and remain immutable while they are being transmitted.

Step 808 includes receiving the message by the smart contract counterparts of the subnet in the host blockchain, where the amount of the withdrawal is unlocked from the host blockchain's smart contracts and released back to the user's crypto wallet in the host chain, thus lowering the locked balances of the host smart contract for the token. In some embodiments, step 808 includes initiating a withdrawal request when the subnet blockchain sends a generic message back to the host blockchain. In embodiments, the balances known by the subnet smart contracts should be equal to the balances locked in the host blockchain smart contracts. That is, balances should be equal between the host chains and the subnet when the message is received in the subnet.

At step 810, the subnet symbol is mapped to a symbol the target host chain expects and can process.

The techniques described in, for example, process 800 may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIG. 8 may be performed by a processor circuit executing instructions stored in a memory circuit, in a client device, a remote server or a database, communicatively coupled through a network including, for example, processor(s) 430, machine-readable instructions 406, participants 110, participants 130, database(s) 152, and network 150.

### Hardware Overview

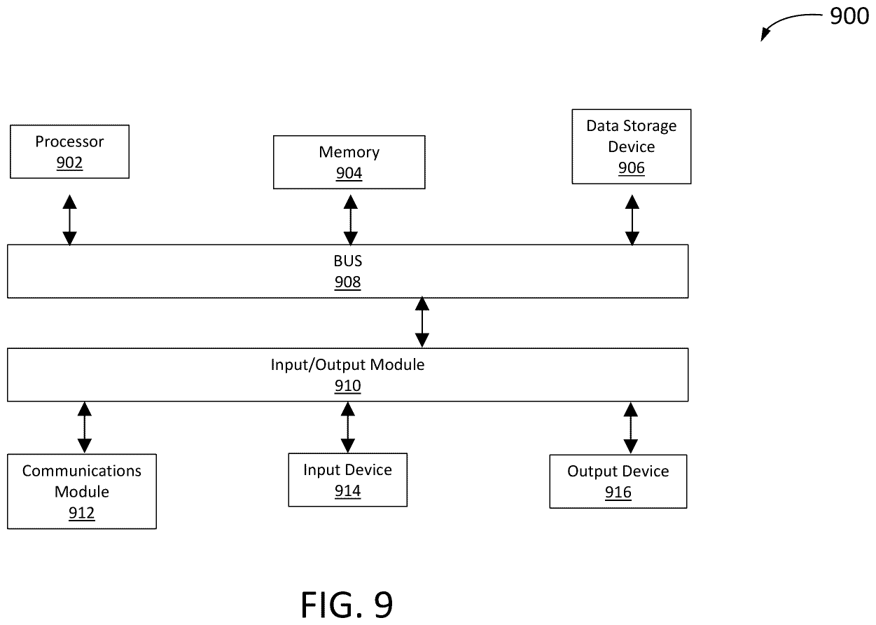

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities.

The computer system 900 (e.g., server and/or participant) includes a bus 908 or other communication mechanism for communicating information, and a processor 902 coupled with the bus 908 for processing information. By way of example, the computer system 900 may be implemented with one or more processors 902. Each of the one or more processors 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. Processor 902 and memory 904 can be supplemented by, or incorporated in, special purpose logic circuitry.

The instructions may be stored in memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by the processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 900 further includes a data storage device 906 such as a magnetic disk or optical disk, coupled to bus 908 for storing information and instructions. The computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

According to one aspect of the present disclosure, the above-described systems can be implemented using a computer system 900 in response to the processor 902 executing one or more sequences of one or more instructions contained in the memory 904. Such instructions may be read into memory 904 from another machine-readable medium, such as data storage device 906. Execution of the sequences of instructions contained in the main memory 904 causes the processor 902 to perform the process steps described herein. One or more processors in a multi-processing arrangement may also be employed to execute the sequences of instructions contained in the memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 900 can include clients and servers. A client and server are generally remote from each other and typically interact through a communication network. The relationship of client and server arises by virtue of computer programs running on the respective computers and having a client-server relationship to each other. The computer system 900 can be, for example, and without limitation, a desktop computer, laptop computer, or tablet computer. The computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 902 for execution. Such a medium may take many forms, including, but not limited to, non-volatile media, volatile media, and transmission media. Non-volatile media include, for example, optical or magnetic disks, such as the data storage device 906. Volatile media include dynamic memory, such as the memory 904. Transmission media include coaxial cables, copper wire, and fiber optics, including the wires that comprise the bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method, comprising:
initiating a transaction for a user in a host blockchain implementing first smart contracts;
generating, at the host blockchain, a message including details of the transaction;
transmitting, via a bridge, the message including the details of the transaction to a target blockchain implementing second smart contracts;
updating a first balance in the first smart contract of the host blockchain based on the message; and
updating a second balance in the second smart contracts of the target blockchain by an amount based on the transaction.

2. The computer-implemented method of claim 1, further comprising, details of the transaction including at least a host symbol and host chain identification (ID), mapping the host symbol to a symbol that is shared across host blockchains in a network.

3. The computer-implemented method of claim 1, wherein the transaction is at least one of a token deposit or a token withdrawal.

4. The computer-implemented method of claim 1, further comprising automatically filling a crypto wallet associated with the user with a gas token of the target blockchain when gas tokens in the crypto wallet drop below a predetermined threshold.

5. The computer-implemented method of claim 1, further comprising:
swapping the host blockchain asset stock for an amount of gas tokens to auto-fill a crypto wallet associated with the user when gas tokens in the crypto wallet drop below a predetermined threshold; and
updating the second balance for the user in the second smart contracts of the target blockchain based on the swapping.

6. The computer-implemented method of claim 1, wherein initiating the transaction in the host blockchain comprises:
locking a token in the host blockchain when the transaction is for a token deposit, and unlocking the token in the host blockchain when the transaction is for a token withdrawal.

7. The computer-implemented method of any one of claim 1, wherein the details of the transaction included in the message comprise a nonce, a transaction type, a user address, a token symbol, the token amount, a quantity, a block timestamp of the token deposit or withdrawal, and custom data.

8. The computer-implemented method of any one of claim 1, further comprising:
receiving, using the bridge, the message from the first smart contracts at the second smart contracts, wherein the bridge is a third-party bridge application.

9. The computer-implemented method of any one of claim 1, further comprising ensuring that the first smart contracts and the second smart contracts only send and accept messages to each other.

10. The computer-implemented method of any one of claim 1, further comprising providing a unique nonce to each message transmitted between the host blockchain and the target blockchain.

11. The computer-implemented method of any one of claim 1, further comprising ensuring that messages between the host blockchain and the target blockchain are not altered by the bridge during transmission.

12. The computer-implemented method of claim 1, further comprising updating a list of blockchain assets of the user including an associated symbol and a host blockchain for each blockchain asset, wherein blockchain assets sharing the same symbol are treated as a single asset.

13. The computer-implemented method of claim 1, further comprising:
tracking balances of blockchain assets across multiple blockchains in a network based on a transaction for a blockchain asset; and
incentivizing users to withdraw a shared token to a host blockchain having a highest inventory of the shared token, and de-incentivizing users to withdraw the shared token to a host blockchain having a lower inventory of the shared token.

14. A system for multi-blockchain trading, comprising:
one or more processors; and
a memory comprising instructions stored thereon, which when executed by the one or more processors, causes the one or more processors to perform:
initiating a transaction for a user in a host blockchain in a network, the host blockchain implementing first smart contracts;
generating, at the host blockchain, a message including at least a host symbol and host chain identification (ID);
transmitting, via a bridge, the message to a target blockchain implementing second smart contracts;
mapping the host symbol to a symbol that is shared across host blockchains in the network;
updating a first balance in the first smart contract of the host blockchain based on the message; and
updating a second balance in the second smart contracts of the target blockchain by an amount based on the transaction.

15. The computer-implemented method of claim 1, wherein the transaction is at least one of a token deposit or a token withdrawal, and the message includes details of the transaction, the details of the transaction comprising a nonce, a transaction type, a user address, a token symbol, the token amount, a quantity, a block timestamp of the token deposit or withdrawal, and custom data.

16. The computer-implemented method of claim 1, further comprising automatically filling a crypto wallet associated with the user with a gas token of the target blockchain when gas tokens in the crypto wallet drop below a predetermined threshold.

17. The computer-implemented method of claim 1, further comprising:
swapping the host blockchain asset stock for an amount of gas tokens to auto-fill a crypto wallet associated with the user when gas tokens in the crypto wallet drop below a predetermined threshold; and
updating the second balance for the user in the second smart contracts of the target blockchain based on the swapping.

18. The computer-implemented method of claim 1, wherein initiating the transaction in the host blockchain comprises:
locking a token in the host blockchain when the transaction is for a token deposit, and unlocking the token in the host blockchain when the transaction is for a token withdrawal.

19. The computer-implemented method of claim 1, further comprising:
tracking balances of blockchain assets across multiple blockchains in a network based on a transaction for a blockchain asset; and
incentivizing users to withdraw a shared token to a host blockchain having a highest inventory of the shared token, and de-incentivizing users to withdraw the shared token to a host blockchain having a lower inventory of the shared token.

20. A non-transitory computer-readable storage medium comprising instructions stored thereon, which when executed by one or more processors, cause the one or more processors to perform operations for multi-blockchain trading comprising:
initiating a transaction for a user in a host blockchain in a network, the host blockchain implementing first smart contracts;
generating, at the host blockchain, a message including at least a host symbol and host chain identification (ID);
transmitting, via a bridge, the message to a target blockchain implementing second smart contracts;
mapping the host symbol to a symbol that is shared across host blockchains in the network;
updating a first balance in the first smart contract of the host blockchain based on the message; and
updating a second balance in the second smart contracts of the target blockchain by an amount based on the transaction.
